(19) United States
(12) Patent Application Publication
(10) Pub. No.: US 2003/0046289 A1
(43) Pub. Date: Mar. 6, 2003

(54) Meta browsing with external execution of third party services

(75) Inventors: Mukund Balasubramanian, Redwood, CA (US); Srinivas Balasubramanian, Redwood City, CA (US); Mohamad Daud, Redwood City, CA (US)

Correspondence Address: Mr. James Bole, Vice President of Engineering, 810 Winslow Street, Redwood, CA, 94063, US

(73) Assignee: Infravio

(21) Appl. No.: 09/947,304

(22) Filed: Sep. 5, 2001

(51) Int. Cl. G06F 7/00

(52) U.S. Cl. 707/10

(57) ABSTRACT

A mechanism is disclosed for processing a transaction over a network. Clients connect over the internet to a web server, which is operatively connected to an integration engine, which is comprised of mediated-agents, one or more wrappers, and a user manager. The integration engine processes a transaction request initiated from a client against a plurality of data sources, which may include, for example, databases, legacy systems, flat files, and web sites, and thereafter transmits a response to the transaction request to the requesting client in real time.

### FIELD OF THE INVENTION

This invention relates generally to distributed computers systems, and more particularly, to a mechanism for processing transactions over a network.

### BACKGROUND

The Internet has become a prominent tool in modern society for its ability to manage and disseminate information. Many people enjoy browsing the graphical component of the Internet, the World Wide Web (“the Web”), for such activities as reading the daily news, entertainment, and online shopping. One common way to browse, or “surf” the Web is to use a web browser, which is a software program that accesses and displays distributed files available over the Web. To use a browser, one enters a web address, called a URL, into the browser to display the web page located at that address on the Web.

Of principal interest when surfing the Web is locating appropriate content to satisfy a user's interest. In addition to “visiting” a web page directly, i.e., using a web browser to display a user-specified web page, content can also be retrieved from the Web through portals. To search for content via a portal, a user submits one or more key words to search upon, and the portal displays a list of links to web sites ranked according to the portal's perception of their relevance to the key words.

Portals employ different techniques to organize content found on the Web, to facilitate searching. One technique is to manually organize the content found on web pages into a hierarchical index by subject. One portal that uses this technique employs human web surfers who manually categorize new web sites into an existing hierarchical index of web sites according to the content they find on the new web sites.

While this technique gives a degree of assurance that the content offered on the web sites is appropriate for its placement within the hierarchy, maintaining the hierarchy is extremely time and labor intensive, and thus, costly. Further, it is difficult to keep up with categorizing new web sites at the same rate as they are being developed. Additionally, there is no efficient mechanism to update the hierarchy when web sites make not insignificant changes to their content, are no longer maintained, or become abandoned.

Accordingly, other portals use automated analysis to organize content on the Web. One such portal using this approach uses software text-matching techniques and mathematical analysis that considers the proximity of key words on web pages, and their referencing web pages, to create an index of web sites. Links on a web page are interpreted as a vote, i.e., a vote by web page A for web page B. A web page is assigned a rank according to the number of votes it receives, i.e., the number of other web sites that have links to it. Additional weight is also generally assigned to a vote cast by a web page that is itself heavily referenced by other web pages. This methodology, however, suggests that the more popular web sites, rather than the more responsive content-based web sites, may be assigned a higher rank, and accordingly, be displayed earlier in search results.

In contrast to portal sites whose search functionality spans the entire breadth of the Web, some web sites offer a more focused search functionality. In these cases, the number of web sites that will likely be searched are limited in number. However, specialized functionality, such as comparison-shopping, may be provided. One such technique involves using a virtual database to facilitate responding to content requests for specific web sites. A virtual database is an application that provides a view in which information can be stored and retrieved from one or more data sources, where at least one of the data sources is not a traditional database. A virtual database, therefore, can be used to store information retrieved from data sources such as web pages, flat files, or legacy systems as if the retrieved information was stored in the respective web sites' databases.

In the example illustrated in FIG. 1, a functional diagram of this technique of using a virtual database is shown with three web sites, namely A.com 102, B.com 103, and C.com 104. When a user surfing the Web desires to initiate a price-comparison search for a particular consumer item, e.g., a specific book, he or she submits a query to the virtual database server 105 of the virtual database 101. The virtual database server 105 then transmits the query to an appropriate wrapper for each data source to be queried. Wrappers provide an interface for data communication between the data source, e.g., the actual web page, and the virtual database 101 by translating information from its native format in the data source to the format used by the virtual database 101.

In an example of a use of a virtual database 101 for a price-comparison search initiated for the book 1984 from a search web site, the query for price information for the book 1984 is transmitted to wrappers 106, 107 and 108 which are responsible for translating data between the virtual database and the respective A.com web site 102, B.com web site 103, and C.com web site 104. Each wrapper, e.g., 106, 107 and 108, executes a query for price-comparison information for the book 1984 in a format distinct and appropriate to its corresponding web site data source. Information satisfying the query is extracted from the respective consumer web site and translated into the virtual database format by the associated wrapper. The collected information is then presented to the user 110.

Implementations of this nature generally use data retrieval mechanisms known as mediators. A mediator is a software module that uses encoded knowledge about the structure of a set of data to enable translation of the set of data into a different structure.

While this approach enables a user to retrieve information from one or more web sites as if the information were stored in a common database, reliance on this pure mediator-based virtual database has drawbacks. While mediators are able to translate data between data structures, they are unable to complete a translation without the complete set of information required by the data source. The data information requirements of a data source must be known prior to a user's query execution. If a mediator is performing a request, or transaction, against a data source which requires more or different information in order to complete the transaction than what the user has supplied in his or her query, or that is otherwise available to the mediator, the mediator will be unable to complete the data extraction, and the user's query will fail.

Another approach to providing search functionality on the Web via a virtual database involves using agents, also known as spiders, crawlers or bots, to gather information from web sites and store the information in the virtual database. An agent is a general term describing a software program that gathers information, or performs some other service, on various existing web sites on a regular schedule, without human intervention.

Agents are used to periodically collect information from various web sites to refresh information stored in their associated virtual database. Accordingly, user content searches, or transactions, are not run against the actual web sites, but rather against the agent-collected information stored in the virtual database. This approach of centrally storing data from a plurality of web sites, however, requires a significant amount of storage space. Such storage space is costly to maintain and must be made available to the internet at all times to be useful. Additionally, agents are slow and inefficient in collecting information. Further, the information stored in the database is generally not current, as the contents on the searched web sites may be expected to be changed frequently, and thus, the web sites' contents will likely have been modified since the last time an agent updated the web site information stored in its associated virtual database.

Thus, it is desirable to provide a mechanism to continue the processing of a user query, or transaction request, on the Web when the transaction request is initiated with incomplete or incorrect information. It is further desirable to provide a mechanism for processing a user query that will provide current information without large storage overhead requirements and/or inefficient and time-consuming data retrievals.

In addition to searching for information from multiple data sources simultaneously, it is desirable to service a transaction request from the user-initiated searching web site, transparently to the user, rather than from the actual data source, e.g., consumer web site. It is further desirable to service transaction requests from multiple data sources effectively simultaneously, and transparently, to the user.

### SUMMARY

The present invention provides for an improved mechanism for processing user queries and transaction requests over a network. According to the present invention, mediated-agents service transactions are performed against one or more data sources. As a result of the techniques described herein, user searches may be performed against a plurality of data sources quickly and efficiently, in real time. Additionally, using the present invention, incomplete or unavailable information in a search query at the time of initiation may be resolved in real time. With the present invention, a user can also initiate one or more actions upon a datum, i.e., a subset of the resultant search information, that is performed by the mediated-agent service's facilities, rather than the actual data source(s), transparently to the user. Additionally, using the present invention, a user can initiate a transaction request from the mediated-agent service site for two or more items that are found at differing data sources.

Other features and advantages of the present invention will become apparent from the following detailed description, taken in conjunction with the accompanying drawings, which illustrate by way of example, the features of the present invention.

### BRIEF DESCRIPTION OF THE DRAWINGS

FIG. 1 is a functional diagram of a virtual database and three data sources;

FIG. 2A is a block diagram of a computer system that can be used wholly, or in part, in the present invention;

FIG. 2B is a block diagram of a general architecture for a processing unit for use in an embodiment of the present invention;

FIG. 3 is a block diagram illustrating a transaction processing system according to an embodiment of the present invention;

FIG. 4 is a flow chart illustrating the process flow of an integrated engine according to an embodiment of the invention;

FIG. 5 is a process flow chart illustrating the steps performed by a mediated-agent according to an embodiment of the invention;

FIG. 6 is a block diagram of a mediated-agent system according to an embodiment of the invention;

FIG. 7 is a block diagram of a mediated-agent system according to another embodiment of the invention'

FIG. 8 is a process flow chart illustrating the steps for adding a new service to an integration engine according to an embodiment of the invention; and

FIG. 9 is a block diagram of a mediated-agent system according to another embodiment of the invention.

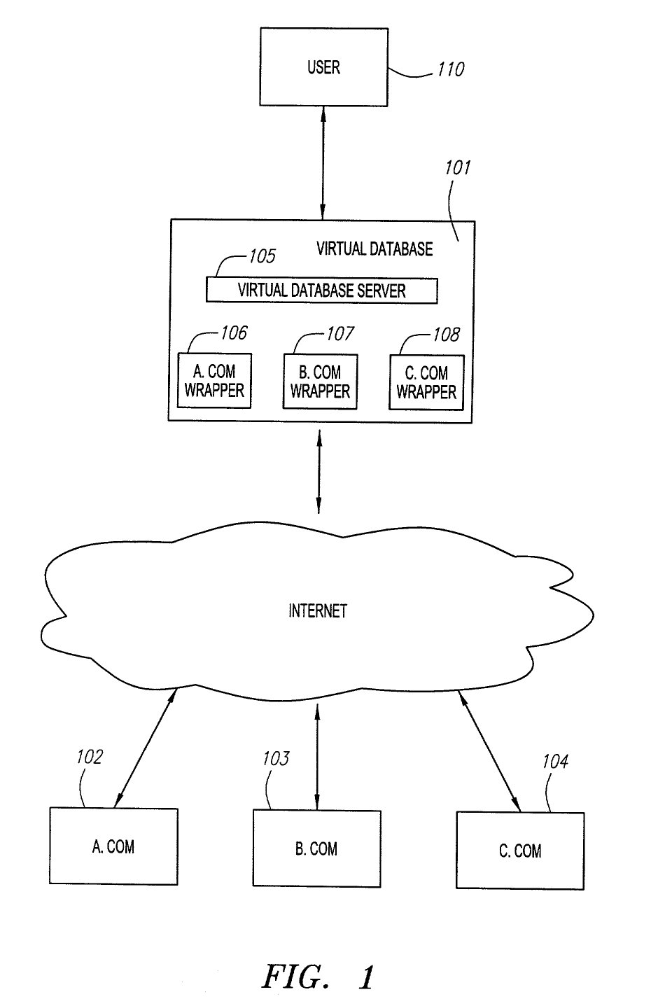

### DETAILED DESCRIPTION OF DRAWINGS

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form and/or described more generally, in order to avoid unnecessarily obscuring the present invention.

I. Operational Overview

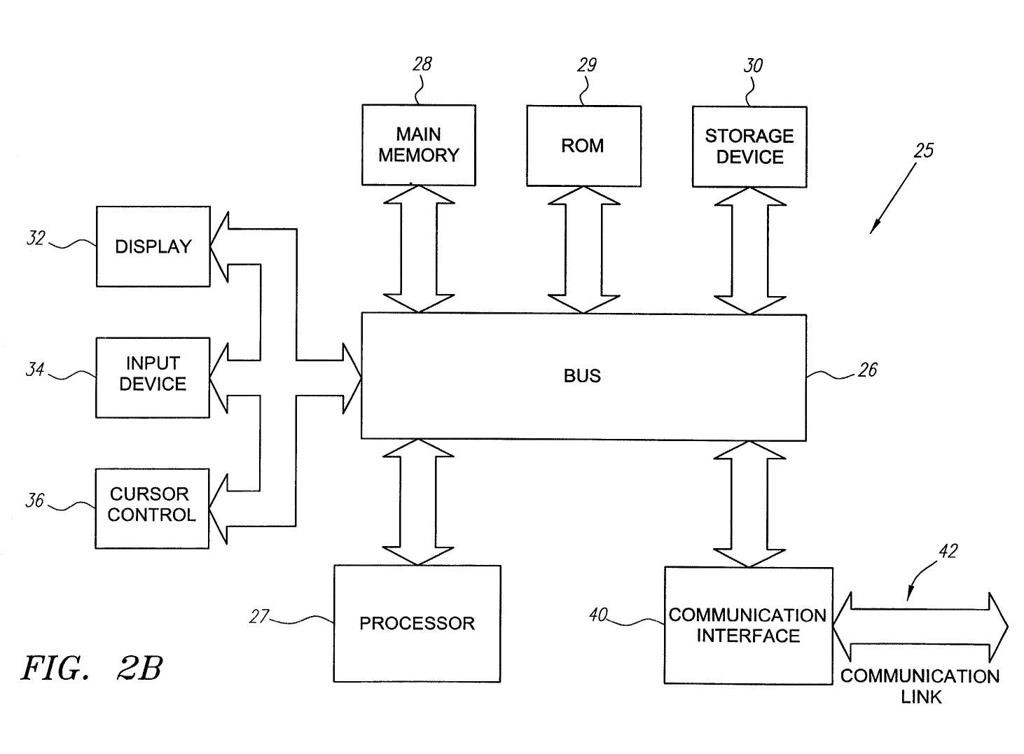

FIG. 3 is a block diagram illustrating a transaction processing system 300 according to an embodiment of the present invention. Transaction processing system 300 has a plurality of clients, e.g., 310, 311 and 312; a web server 320; and an integration engine 330. The plurality of clients 310, 311 and 312, as used herein, broadly refers to devices configured to send information to and receive information from the web server 320 via one or more of a plurality of transmission protocols. In an embodiment, the plurality of clients 310, 311 and 312 are software modules operating on hardware devices, such as person computers, that are capable of communicating with the web server 320 via the HTTP protocol, such as, for example, a web browser. In another embodiment, the plurality of clients 310, 311 and 312 may be portable devices capable of communicating with the web server 320 over the WTP protocol, such as, for example, personal digital assistances (“PDAs”) or wireless phones.

Web server 320 is operatively connected to the plurality of clients, 310, 311 and 312, and to the integration engine 330. Web server 320 is a component that, as used herein, broadly refers to any component that has the capability to receive and respond to transaction requests, including requests for content, from the plurality of clients 310, 311 and 312.

Integration engine 330 is operatively connected to web server 320. Integration engine 330 processes transaction requests transmitted by the web server 320 against a plurality of data sources, e.g., 350, 351 and 352. The integration engine 330 communicates with the web server 320 and the plurality of data sources 350, 351 and 352 via one or more of a variety of known protocols, such as, for example, HTTP, XML, WTP or SQL. Integration engine 330 is comprised of a plurality of mediated-agents 335; a plurality of wrappers, e.g., 340, 341 and 342; and a user manager 360.

The plurality of mediated-agents 335 facilitate transaction processing within the integration engine 330. The plurality of mediated-agents 335 are coupled to the plurality of wrappers 340, 341 and 342, and thus, to the plurality of data sources 450, 451 and 452. The plurality of mediated agents 335 are also coupled to the user manager 360.

The plurality of data sources 450, 451 and 452 are sources from which data may be retrieved, such as, for example, databases, web pages, flat files or legacy systems. Each of the plurality of data sources 450, 451, and 452 may store information in its own unique format. Thus, across the plurality of data sources 450, 451 and 452, there will likely be a variety of heterogeneous formats employed for storing the respective data source information.

The plurality of wrappers 340, 341 and 342 provide an interface for data communication between the plurality of data sources 450, 451 and 452 and the plurality of mediated-agents 335. The plurality of wrappers 340, 341 and 342 translate information between the native format for representing information used by the mediated-agents 335 and the data format used by the respective data sources 450, 451 and 452. This format translation is necessary to create a representation of data in a homogenous format that has been collected from a plurality of data sources 450, 451 and 452 that employ a variety of differing formats.

The user manager 360 stores information about the users, of the clients, that is then employed in servicing transaction requests. In an embodiment, user information is used by the transaction processing system 300 for servicing all transaction requests. In other embodiments, user information is used by the transaction processing system 300 for servicing a subset of transaction requests. The user manager 360 stores the information pertaining to a particular user in a profile which is accessible by both the user and the plurality of mediated-agents 335.

In transaction processing system 300, each of the plurality of clients 310, 311 and 312 can transmit transaction requests to the web server 320. The web server 320 receives each transaction request and transmits information identifying the transaction request to the integration engine 330. As used herein, the term transaction request is broadly used to represent a wide range of transactions. Non-limiting examples of a transaction request include a request for information, a request for web content, a request to perform a remote procedure, and a request to perform an action on a remote machine. Transaction requests can include, although are not limited to, gathering comparison information on specified consumer items or services, purchasing requests for one or more consumer items or services, or posting information, such as an offer for sale of an item, or a resume, to one or more web sites.

The integration engine 330 services the transaction requests, and may transmit back response information to the requesting client. The term response information, as used herein, identifies a stream of information transmitted by the integration engine 330 in servicing, or failing to be able to service, a transaction request. For example, if the transaction request is a request for content, e.g., information on an item offered for sale on a web site, the response information transmitted to the requesting client includes the requested content, e.g., the item description, sales price, etc. As another example, if the transaction request is a request to initiate the performance of a remote action, such as the purchase of an item offered for sale on a web site, the response information can include information resulting from the performance of the requested remote action, e.g., acknowledgment that the purchase request has been processed.

In an embodiment, response information is streamed by the integration engine 330 to the client, either directly, or via the client's associated web server 320, in real time. Thus, in an embodiment, response information for a transaction request is not obtained and stored in a database prior to the integration engine 330 servicing the transaction request, as is done by known agent-based systems. In this manner, data storage requirements are minimized.

In an embodiment, aggregate data from a plurality of data sources, e.g., 450, 451 and 452, that is responsive to a transaction request is displayed to the user in a unified, or homogeneous, format. For example, in serving a transaction request for web content collected and organized from a plurality of data sources, e.g., 450, 451, and 452, the response information may be displayed in an integrated arrangement by subject, rather than by source. For other transaction requests, however, the collected response information may be more appropriately displayed by source, e.g., when a user has initiated a transaction request for comparison pricing of a specific consumer item. In an embodiment, for at least comparison response information, the collected response information is displayed in the same format, including the same font, and in the same order, for each of the sources, rather than in the individual formats of the various data sources the response information was collected from.

In an embodiment, when a user first accesses the transaction processing system 300, e.g., the first time the user uses the transaction processing system 300 to visit a particular web page, the integration engine 330 generates a user identifier for the user. A user identifier is a unique data string that identifies a particular user using the transaction processing system 300. In an embodiment, a user identifier is used to identify a particular client. In another embodiment, a user identifier is used to identify a particular computer. In still another embodiment, the user identifier is used to identify a particular person. In yet another embodiment, the user identifier is used to identify one or more people in a related group, such as a family or business. A user, as used herein, is any entity or party identified by a user identifier.

The user identifier may be generated by numerous known means, including means for generating a unique number. In a non-limiting, illustrative example, the user identifier may be generated by determining the time after a set interval, in milliseconds, that the first request from the user is received by the transaction processing system 300 concatenated with one or more random numbers.

In an embodiment, the user identifier may be stored in or on the client by one or more of a variety of known means, such as a via a computer cookie. In embodiments of the invention, a user identifier accompanies the transaction requests from the client, thus allowing the user to be identified. In an embodiment, the user identifier is alternatively, or also, stored in the integration engine 330. In other embodiments, a user is authenticated by manually entering the appropriate user identifier, or a username/password combination associated with the user identifier, to establish a secure session with the integration engine 330.

Having thus described the functional overview of the transaction processing system 300, the operation of the integration engine 330 is described below in further detail.

II. Integration Engine

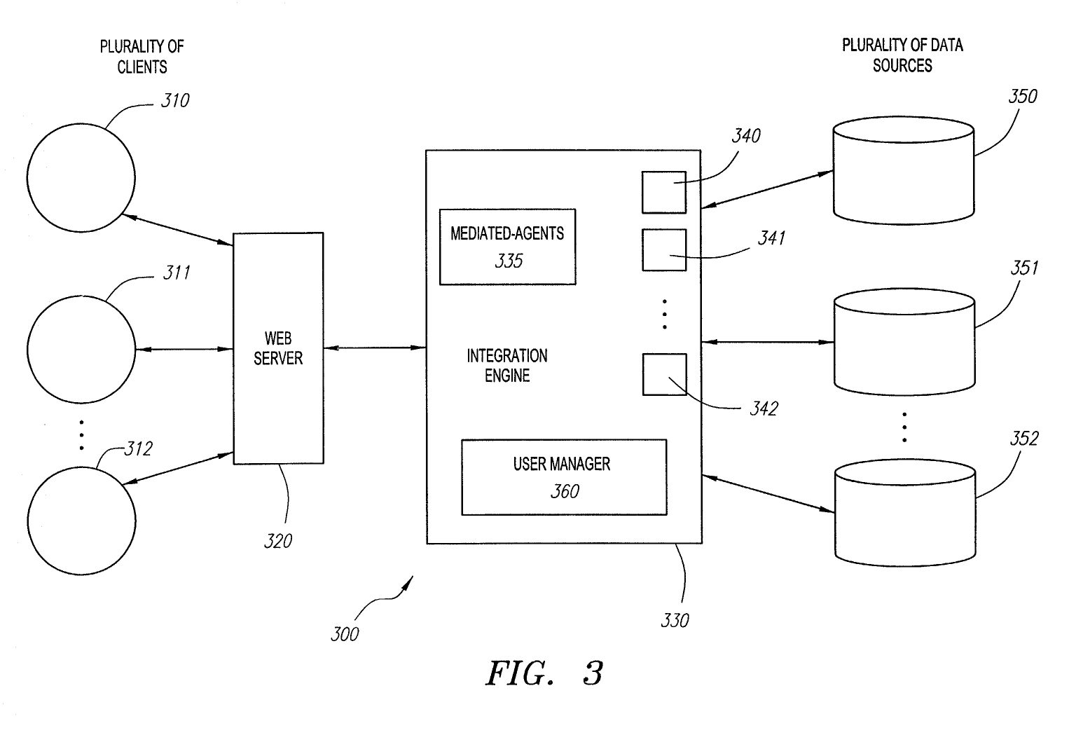

The process flow of integrated engine 330 according to an embodiment of the invention will now be described with reference to FIG. 4. The integrated engine 330 receives (410) information identifying a transaction request from the web server 320.

After the integrated engine 330 receives the transaction request, the integrated engine 330 identifies (420) the transaction type of the transaction request. The integrated engine 330 examines the information comprising the transaction request to determine what type of request it is. In an embodiment, a transaction type is the key that maps a transaction request to one or more of the plurality of mediated-agents 335 that perform that type of transaction. There can be any number of transaction types, depending on, in part, the level of granularity the transaction processing system 300 is designed to support. With more specific transaction types supported by a transaction processing system, a significant portion of the parsing of a transaction request is done at the beginning of the transaction processing, and the mediated-agent structure is generally more flat. Alternatively, with less specific transaction types identified for a transaction processing system, a significant portion of the parsing of the transaction request is done throughout the transaction processing, and the mediated-agent structure is generally deeper.

In an embodiment example, a request for web content is one transaction type and a request to purchase an item is another transaction type. In another embodiment example, these transactions are of the same transaction type. In various embodiment transaction processing systems 300, a request to purchase an item may be alternatively divided into transaction types that correspond to the nature of the goods or services to be purchased, with varying degrees of granularity. For example, purchasing food may be one transaction type in one transaction processing system 300, while in an alternative transaction processing system 300, purchasing fruit, purchasing meat, purchasing vegetables, etc., may be the identified transaction types.

In embodiments of the invention, a specific mediated-agent identifies the transaction type of the transaction request. In other embodiments, the transaction type is resident within the information of the transaction request.

After the integrated engine 330 identifies the transaction request type, the integrated engine 330 routes (430) information for the transaction request to the particular mediated-agent responsible for processing the transaction request type. For example, information for a transaction request for placing travel reservations with an airline can be transmitted to one particular “airline travel reservation” mediated-agent of the plurality of mediated agents 335. In this same example, information for a transaction request for placing a travel reservation with a rental car agency will be transmitted to the “car rental reservation” mediated agent of the plurality of mediated agents 335. In another example, a transaction request for an airline reservation of a car rental reservation can be transmitted to a “transportation reservation” mediated agent of the plurality of mediated agents 335.

After an appropriate mediated-agent is routed the information for a transaction request, the mediated-agent processes (440) the transaction request. In processing the request, the mediated-agent analyzes the transaction request, decomposes the transaction request, as necessary, into sub-queries, and extracts the data to satisfy the transaction request from one or more of the plurality of data sources 350, 351 and 352. Step 440 is explained in further detail below.

In an embodiment, after the mediated-agent processes the transaction request, the integrated engine 330 streams (450) response information to the requesting client. In an embodiment, the integration engine 330 streams the response information to the web server 320 for the requesting client. In another embodiment, the integrated engine 330 streams the response information to the requesting client directly.

In an alternative embodiment, the integrated engine 300 streams response data, as it is gathered and collated during the mediated-agent's processing of the transaction request, to the requesting client.

Having thus described the operation of the integration engine 330, the operation of processing a transaction request by a mediated-agents 335 is now described.

III. Mediated-Agents

Each of the plurality of mediated-agents 335 is a special form, or hybrid, mediator and agent. In an embodiment, the mediated-agents are arranged in a tree structure with each mediated-agent having the ability to communicate with both its parent node mediated-agent and any of its child node mediated-agents. In an embodiment one mediated-agent of the plurality of mediated-agents communicates with the web server 320, and/or, with one or more of the plurality of clients 310, 311 and 312.

In an embodiment, a first, or “top” mediated-agent is responsible for determining the transaction request type. This top mediated-agent then communicates with its child mediated-agents, which are each responsible for servicing a transaction request type supported by the transaction processing system 300. In an embodiment the top mediated-agent is also responsible for transmitting the response information to the clients.

In an alternative embodiment, the transaction request type is included in the transaction request, and each of the top mediated-agents are responsible for servicing a transaction request type supported by the transaction processing system 300. In an embodiment, each of the top mediated-agents can transmit response information to the clients.

In alternative embodiments, whether or not the transaction request type is included in the transaction request, only one, or a subset of the mediated-agents of the plurality of mediated-agents 335 may transmit response information to the clients.

In an embodiment, the leaf mediated-agents, which do not have child nodes, are operationally connected to the plurality of data sources 350, 351 and 352, and thus, can communicate with their parent node mediated-agent and the data source(s) they are operationally connected to. In an embodiment, a leaf mediated-agent is operationally connected to only one data source. In an alternative embodiment, one or more leaf mediated-agents are operationally connected to two or more data sources.

Each of the plurality of mediated-agents 335 communicate using an established protocol, involving generating and transmitting sub-queries from the top mediated agent in the tree structure responsible for servicing the particular transaction type, through the mediated-agents in the tree branch(es) for the transaction type, to the leaf mediated-agents responsible for interfacing with the data source(s). The established protocol further involves collecting, and as the tree is traversed in the reverse direction, back to the top mediated-agent, collating response information to be presented to the user.

Each of the plurality of mediated-agents 335 can also conduct “dialogues” in which the mediated-agent ascertains information and/or properties from others of the plurality of mediated-agents 335 through directed queries. For example, a particular mediated-agent may ask its parent node for information that it does not itself know but that it requires in order to complete the processing of the transaction request. As an example, a mediated-agent may send a directed query to its parent node to determine whether the user wishes to pay for items purchased via the transaction processing system 300 by check or credit card.

The number and tree-structure arrangement of mediator-agents can vary from transaction processing system 300 to transaction processing system 300, and can depend upon, at least in part, the specific services 352 supported by the transaction processing system 300, and the composition of the resultant plurality of data sources 350, 351 and 352 used by the transaction processing system 300. Thus, different embodiments of the invention may provide the same or similar functionality with different arrangements and/or numbers of mediator-agents. Further, embodiments of the invention are not limited to any particular number or arrangement of mediated-agents, as, for example, the efficiency of a particular number or arrangement of mediated-agents may vary from implementation to implementation.

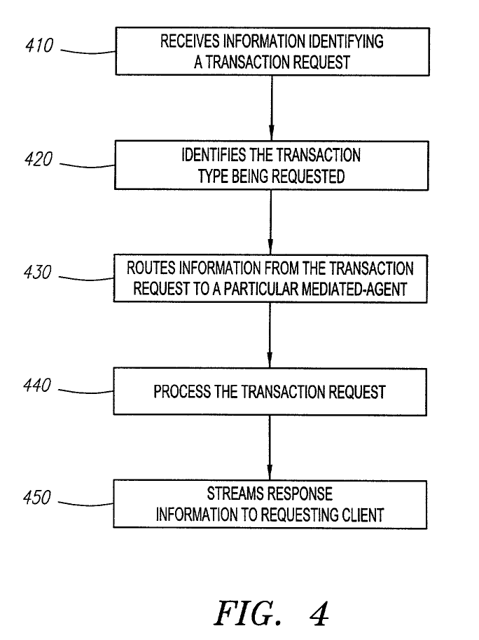

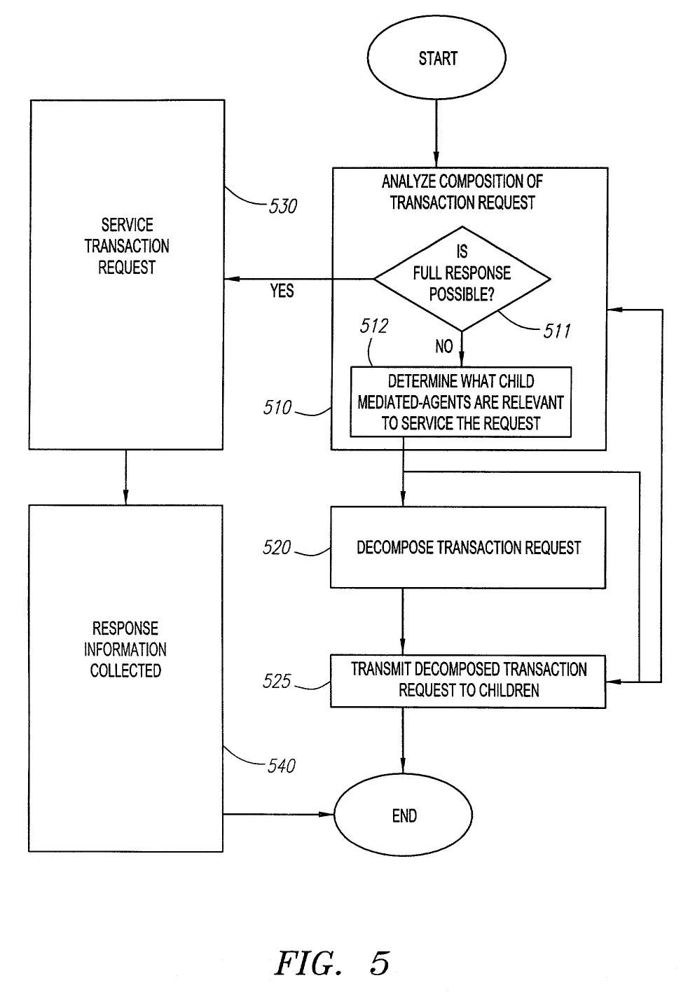

FIG. 5 is a process flow chart of an embodiment of the invention illustrating the steps performed by the plurality of mediated-agents 335. FIG. 6 is a functional block diagram illustrating the implementation of mediated-agents according to an exemplary embodiment of the present invention. With reference to FIGS. 5 and 6, the steps performed by mediated-agents in processing a transaction request will be described through an example wherein a user has initiated a transaction request to comparison shop for the book Hawaii.

After the transaction request type is identified in step 420, the appropriate mediated-agent for servicing the transaction request type is identified. In the present example, as it involves comparison shopping for a particular book, we will use the transaction type “shop”. Of course, other transaction types be used as well, such as, more specifically, “shop for books” or, more generally, “goods”. In our example, accordingly, the mediated-agent 335 responsible for servicing transaction requests with the type “shop,” e.g., shop mediated-agent 33A of FIG. 6, is routed the necessary transaction request information.

Upon the particular mediated-agent receiving the transaction request information, the mediated-agent analyzes (100) the composition of the transaction request. In analyzing the transaction request (510), the mediated-agent 335 determines (511) if it can fully respond to the transaction request. If it cannot, the mediated-agent then determines (512) the child mediated-agents that are relevant to assist in servicing the transaction request. For example, shop mediated-agent 335A analyzes (510) the composition of the transaction request for comparison shopping for the book Hawaii, and determines (511) that it cannot service the transaction request itself, as shop mediated-agent 335A is not operatively connected to any data sources from which to retrieve information. Shop mediated-agent 335A then determines (512) that book mediated-agent 335C is relevant for servicing the transaction request.

In our example, shop mediated-agent 335A would not determine that child nodes CD mediated-agent 335B and widget mediated-agent 335D are relevant to servicing the transaction request, as neither of these are concerned with books.

The determining (512) of the child node mediated-agents to use in responding to a transaction request can be performed by a variety of methods, including storing a set of transaction types that can be processed by the parent mediated-agent's child node mediated-agents with or at the parent mediated-agent. Thereafter, a comparison of the requested transaction type with the stored transaction type information can identify the corresponding child node mediated-agents to be used in servicing the transaction request.

After analyzing the transaction request, the mediated-agent, e.g., shop mediated-agent 335A, can either pass the transaction request directly on to the relevant child mediated-agent(s) for processing (525), or, alternatively, it decomposes (520), or otherwise parses or divides, the transaction request into smaller transaction requests, or queries, to be processed by the child mediated-agents. Thus, after a particular parent mediated-agent identifies the child nodes it requires to assist in servicing a transaction request, the transaction request may be divided into smaller queries appropriately to be handled by each child mediated-agent. The parent mediated-agent then transmits the smaller queries (525) to the respective child node mediated-agent(s).

In our example, shop mediated-agent 335A will transmit (525) essentially the entirety of the necessary transaction request information to book mediated-agent 335C. In an alternative example, a user may have requested comparison shopping for Hawaii-based items. In this alternative example, the shop mediated-agent 335A will decompose the transaction request (520) into various queries, one for each of its child nodes. Thus, in this alternative example, shop mediated-agent 33A will decompose the user transaction request for Hawaii-based items (520) into three queries: a query for Hawaii-related CDs, which is then sent (525) to CD mediated-agent 335B; a query for Hawaii-based books, which is then sent (525) to book mediated-agent 335C; and a query for Hawaii-related widgets, which is then sent (525) to widget mediated-agent 335D.

When the child mediated-agents receive a query from their parent node, each child mediated-agent performs step 510. For example, upon receiving the transaction request information for comparison shopping for the book Hawaii, book mediated-agent 335C performs step 510. This process continues until a query relevant to the transaction request is received by a leaf mediated-agent, which, as previously explained, is a mediated-agent that have no child nodes and is operationally connected to a data source for the transaction processing system 300.

For example, in performing step 510, book mediated-agent 335C makes a determination that it cannot fully respond to the transaction request, and that its child mediated-agents 335E, 335F and 335G are relevant to servicing the transaction request, as each may help obtain price-information on the book Hawaii. Book mediated-agent 335C decomposes the transaction request (520) into smaller, sub-queries to be serviced by the respective mediated-agents 335E, 335F and 335G. In our example, the book mediated-agent 335C will transmit a query for price information for the book Hawaii (525) to the Acme Book mediated-agent 335E. Book mediated-agent 335C will likewise transmit a query for price information for the book Hawaii (525) to the Beta Book database mediated-agent 335F. Similarly, book mediated-agent 335C will transmit a query for price information for the book Hawaii (525) to the Legacy System mediated-agent 335G.

When each leaf node mediated-agent, e.g., mediated-agents 335E, 335F and 335G, performs step 510 upon receiving a query from their parent node book mediated-agent 335C, each leaf node mediated-agent analyzes the query and determines (515) that it can service the query.

The leaf mediated-agents service (530) the query, and ultimately, the transaction request, by extracting data from their respective data source. In an embodiment, a leaf mediated-agent uses a wrapper to communicate with the data source, to extract the requisite information to satisfy the query. Using a wrapper, the mediated-agent can reformat, or otherwise translate, the query into a format acceptable to the data source, to be able to effectively communicate with the data source to retrieve the information responsive to the query.

In an embodiment, one or more of the leaf mediated-agents need not use a wrapper when transmitting information requests to the data source, because, for example, the query is already in a format acceptable by the data source. Alternatively, a leaf node mediated-agent may have no need for a wrapper because it comprises logic, or programming steps, for effectively communicating with the data source's input interface(s). For example, leaf node mediated-agent 335E may not need the use of a wrapper when communicating with the Acme Book web site because mediated-agent 335E has logic to input the information for obtaining book price information required by Acme Book's web site form.

In servicing its respective query, each leaf node mediated-agent collects (540) response information from its corresponding data source(s). Each parent mediated-agent collects response information transmitted from its child node(s), and consequently transmits the collected response information to its parent node. The process continues in this way until the top mediated-agent receives a set of collected response information for the transaction request.

In an embodiment, each parent mediated-agent in the tree branch for a transaction request collects and collates the response information from its child nodes. In an alternative embodiment, each parent mediated-agent in a tree branch collects and passes response information collected from its child nodes to its parent node, and the top mediated-agent in the plurality of mediated agents 335, or the top mediated-agent responsible for the transaction type, collates the response information collected from all its child, grandchild, etc. nodes.

In an embodiment, the response information is then either streamed to the client via the web server 320 or directly to the client. In another embodiment, response information is collated and passed up the tree structure of mediated agents, and is streamed to the client as it is received by the top mediated-agent.

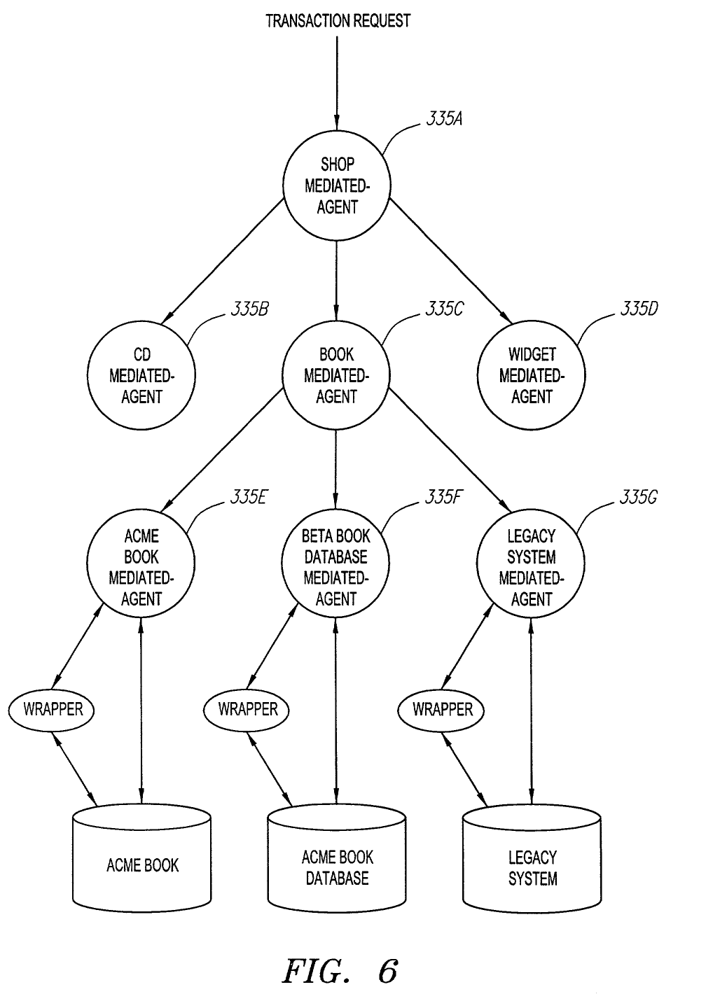

As explained, the transaction request, generally as sub-queries, propagates down the hierarchy of mediated-agents until leaf node mediated-agents can service the transaction request by extracting data from the data sources. If at any point a mediated-agent is unable to process a transaction request, or sub-query, due to lack of information, the mediated-agent opens a dialogue with its parent node to attempt to resolve the problem. An example of resolving an issue of missing information by opening dialogues is explained in reference to FIG. 7, which is a functional block diagram illustrating mediated-agents in an embodiment of the invention.

In the example of FIG. 7, mediated-agent 335Q is servicing a sub-query to make a reservation on a United Airlines flight. In order to make a reservation, the United Airlines web site asks whether the user wishes a window or aisle seat. In our example, the mediated-agent 335Q does not know this information, either because it is not part of the information in its query, and/or the user has never provided this type of information before to the transaction processing system 300. The transaction request cannot be completed, however, until the mediated-agent 335Q provides this information to the United Airlines web site.

Mediated-agent 335Q can resolve this problem by opening a dialogue with its parent, domestic flights mediated-agent 335P. Mediated-agent 335Q asks its parent mediated-agent 33P if it knows whether the user submitting the transaction request desires a window or aisle seat. If mediated-agent 335P does have this information, it communicates the user's seat preference back to mediated-agent 335Q, which then continues to process the reservation request with the United Airlines web site.

If parent node 335P does not know the user's seat preference, parent node 335P can open a dialogue with its own parent node 335M to inquire if the airplane mediated-agent 335M has the user's seat preference information. This process of traversing up the mediated-agent hierarchy will continue until a particular mediated-agent is operatively connected to user manager 360, such as, in this example, travel mediated-agent 335K. The seat preference information needed to continue processing the transaction request may be stored in user manager 360. Accordingly, the appropriate user profile in user manager 360 is accessed by mediated-agent 335K to determine if it contains the needed missing information. If the user's airline seat preference is stored in the respective profile in the user manager 360, then the particular mediated-agent accessing the user manager 360, e.g., 335K retrieves the information and transmits it, via node 335M and then node 335P, to the appropriate leaf mediated-agent 335Q. Mediated-agent 335Q uses the information to continue processing the user's transaction request. The operation of user manager 360 is explained in further detail in the next section.

If the mediated-agents for a transaction request type and the user manager 360 are unable to supply the missing information, the integration engine 330 asks the user to provide the missing information. If the user is still online, the user is asked to provide the missing information through any of a variety of mechanisms for collecting information in a network, such as, for example, a pop-up box, a question field, or even an audio request. In an embodiment, if the user is offline when the missing information needs to be supplied, the integration engine 330 will store an appropriate request to present to the user, to ascertain the necessary missing user information at a later date. In an embodiment, the user is requested to provide the missing information via a web page that is accessed by his client when he comes back online.

The operation of the user manager 360 will now be described in further detail.

IV. User Manager

The user manager 360 stores information about each user of the transaction processing system in a separate user profile. In an embodiment, an authorized user may record, revise and/or update information in his or her profile at any time. In an embodiment, information requested of a user by the integration engine 330 when the mediated-agents are processing a user transaction request is also thereafter stored in the user's profile.

In an embodiment, a user is queried on a variety of information, including, e.g., identification information, preference information, etc., when the user first uses, or otherwise registers with the transaction processing system 300.

Non-limiting illustrative examples of the type of data stored in the user manager 360 include information identifying the user, such as their name, the user's shipping and billing address information, the user's shopping, travel, etc. preferences, and the user's payment instrument information, e.g., his or her credit card information. The type of information stored in the user's profile can, in part, be dependent on the plurality of data sources 350, 351 and 352 of the transaction processing system 300. For example, a transaction processing system 300 that handles travel reservations may include airline seat preference information in the user's profile, while a transaction processing system 300 that is not established to service this type of transaction request will have no particular need for this information. Moreover, even if the transaction processing system 300 handles, e.g., the processing of airline travel reservations, if none of its plurality of data sources 350, 351 and 352 require a user's seat preference to complete a reservation transaction, then, again, this information has no particular use in the users' profiles.

In an embodiment, more complex data, such as formatted documents and prior search results, may also be stored in the user manager 360. In an embodiment, information identifying a user's account with merchants or vendors accessible by the transaction processing system 300 is stored in the user manager 360.

In an embodiment, after being authenticated by the transaction processing system 300, a user can manually customize the information contained in his or her corresponding profile. In an embodiment, information in a user's profile may be automatically updated, for example, when a user is awarded a special coupon or preferred status perks. It is not necessary for any information to be present in a user's profile, however, for the user to use the transaction processing system 300.

An eWallet is a subset of the information stored in a user profile that is generally necessary to conduct a transaction with a merchant. Hence, information such as a user's resume could be stored in the user's profile, but will not generally be in the user's eWallet. In an embodiment, only the eWallet, and not the user's profile, is accessible to the user, for adding to, deleting from or otherwise modifying the contents of. In other respects, the eWallet behaves or functions like a user profile.

Various web sites offer personalized services or additional content when input data is submitted. For example, a web site featuring weather information may provide a tailored weather report for a particular region upon receiving a city name or a zip code as input. Other web sites require a more complex set of input data. For example, an auction site may require input data that identifies a particular item, the bidder, the bidder's bid limit, and an address to ship the item that is successfully bid on.

These types of input information may, but need not, be stored in a user's profile. Storing this information in a user profile can be desirable, as it will allow embodiments of the invention to have access to this information to more quickly and efficiently service transaction requests from the user, with a minimum amount of subsequent user interaction.

As previously described, if a mediated-agent cannot service a query for a user transaction request due to a lack of information required by a responsive data source, a request for the missing information can be propagated to the user manager 360, or alternatively to the user, through the various mediated-agents in the tree branch for serving the user's transaction request type. In an embodiment, if the missing information is retrieved from the user, it can also be then added to the user's profile in the user manager 360, for use with subsequent transaction requests.

In an embodiment, information stored within the user manager 360 can be accessed by the user in formulating his or her transaction request. For example, information stored within a user's profile may be presented to the user through a graphical user interface for selection and subsequent incorporation within the user's transaction request.

In an embodiment, the integration engine 330 “learns” when a particular item of information is required by one of its plurality of data sources 350, 351 or 352 when a first user issues a transaction request that requires the information. Thereafter, in an embodiment, the integration engine 330 can query the transaction processing system's other users, or, alternatively, only those users identified as likely to issue the same transaction request type requiring this information, when these users subsequently access the transaction processing system 300, or, alternatively, when they issue a transaction request for the transaction type. The supplied information is then stored in the user's profile and/or eWallet.

In an alternative embodiment, the leaf node mediated agents can, on command to the integration engine 330, or, alternatively, periodically, access their data source with a typical request, and thereby ascertain if the data source requires additional information not included in the request. If the leaf node mediated agent is missing information to complete the request to its data source, it will open a dialog to it parent node, informing the parent node of the new information the data source requires. In an embodiment, this new information requirement is propagated up the mediated-agent tree branch, to either the user manager or the top mediated agent in the plurality of mediated-agents 335. Thereafter, when a user accesses the transaction processing system 300, the integration engine 330 can query the user for the necessary missing information for the data source, in preparation for any future user transaction request that will require this information.

V. Services Enabled Through Embodiments Of The Invention

Embodiments of the invention provide mechanisms to perform searches and other transaction requests against a plurality of data points, or sources, in real time, and stream response information to the user in real time. The user may initiate one or more actions upon a datum, i.e., a subset of the response information, in a subsequent transaction request to integration engine 330. Thus, a user can search for an item in a plurality of data sources 350, 351 and 352, and may then request one or more actions be performed on that item, once found, by one or more of the data sources originally searched, or an entirely different data source.

In an embodiment of the invention, a user may request a sales price for a specific item, e.g., the book Hawaii, from two or more internet merchants, e.g., buy.com and Amazon.com. The user, based on the received response information, may then desire to purchase the item from one of the searched internet merchants, or alternatively, a third internet merchant, e.g., BarnesandNoble.com. By initiating the purchase transaction request from the current web page associated with the integration engine 330, the user's purchase is made on the merchant's web site via the plurality of mediated-agents 335 transparently to the user, without the user leaving the current web site and having to access the merchant's website. Information from the user's profile is used by the plurality of mediated-agents 335 to effect the purchase transaction on the merchant's website. If information is required to complete the transaction on the merchant's website that is not found in the user's profile, the user can be queried for the information, via, e.g., a popup block or question field, on the current, integrated engine-related, web site. In an embodiment, response information confirming the transaction is streamed back to the user's client for display in the context of the integrated engine-related web site in real time.

Embodiments of the invention act upon multiple items from varying data sources at once, e.g., when a plurality of items are purchased by the user at once. With a single action, e.g., a checkout, actions may be initiated, e.g., transaction purchasing requests may be issued, to multiple vendors or merchants. For example, a user can add various items from different merchant websites to his or her shopping cart on the integration engine-related web site. When the user initiates a checkout request, respective transaction purchase requests are initiated effectively simultaneously for the various merchants. The responsible mediated-agents will then handle the various transaction purchase requests without the user having to access or otherwise traverse the various merchant web sites. In this manner, a user can have one point of contact for effectively simultaneous transaction requests for multiple data sources, e.g., 350, 351 and 352. Additionally, in these embodiments the user does not have to input or confirm processing information for each of the various merchant web sites. Such repetitive purchase information input and/or confirmation can be inefficient and time consuming when, for example, the user simply wants a variety of items to be paid for by the same credit card and shipped to the same address.

Embodiments of the invention can be used to provide job-searching functionality. Information relevant to a desired position of employment, such as a resume, desired position, location and salary, can be stored in the user's profile, or, alternatively, or in addition, dynamically entered by the user when formulating their job-searching transaction request. Content can be collected from a plurality of job placement web sites by the plurality of mediated-agents 335 and presented to the job seeker. Additionally, information either in the user's profile, e.g., a resume, desired position, and/or contact information, or information entered into the transaction processing system 300 dynamically by the user, may be posted by the plurality of mediated-agents 335 on one or more of the plurality of job placement web sites. In this manner, job comparisons can be effectively performed across a plurality of data sources 350, 351 and 352.

Other embodiments of the invention can be used to provide travel research and reservation functionality. Information relevant to a travel expedition, such as the desired mode of transportation, dates of travel, desired budget constraints, and start location and destination, may be stored in the user's profile, or dynamically input by the user in creating his travel-related transaction request. Content may be collected from a plurality of travel web sites by the plurality of mediated agents 335 and presented to the would-be traveler. Additionally, information either in the user's profile, e.g., data requesting a particular desired trip, or information entered into the transaction processing system 300 dynamically by the user, can be posted by respective mediated-agents on the plurality of travel web sites, and used to provide information and comparison shopping to the would-be traveler. Once a desired trip is identified, the would-be traveler can then take a variety of actions, such as booking the trip, initiating a reverse-auction on the trip, or posting an inquiry for further information about the trip. These subsequent actions may be performed by the plurality of mediated-agents 335 accessing one or more web sites that are different from the original web site(s) used to provide the initial travel information to the user. For example, a would-be traveler can use embodiments of the invention to search for a cruise within a certain budget from San Francisco to Alaska. Once a particular cruise is identified, the user can then submit information about the selected cruise to a plurality of additional, or alternative web sites, via the plurality of mediated-agents 335, for example, to initiate a reverse-auction on the cruise, to initiate a price-comparison search, or to initiate more research on the cruise.

Other embodiments of the invention may be used to support heterogeneous email functionality. Information pertaining to email accounts, e.g., a set of one or more email addresses, a set of one or more usernames, and an address book, may be stored in the user's profile in the user manager 360. Using information either stored within the user manager 360 or dynamically input by the user in creating his email-related transaction request, the plurality of mediated-agents 335 can support the user accessing one or more email accounts associated with one or more other, email, web sites. Email messages, which may originate from a variety of sources or originating mailboxes, can be collected by mediated-agents and presented to the user in a unified format. In these embodiments, therefore, the user can check multiple email accounts effectively simultaneously. The user can also compose email and cause the composed email to be sent from an originating mailbox by using the mediated agents of the transaction processing system 300 to transmit the composed message, and the transmission destination information, to the originating mailbox, for subsequent transmission to the ultimate destination(s).

Other embodiments of the invention may be used to support auction and reverse-auction functionality. Information relevant to initiating an auction or reverse-auction, such as a product information, desired price and contact information, can be stored in the user's profile, and/or dynamically input by the user in formatting his or her auction, or reverse-auction, transaction request. Content may be collected by mediated-agents from a plurality of web sites and presented in a meaningful, unified manner to the user. Additionally, information within the user manager 360, e.g., product and desired price, or information dynamically entered by the user, can be posted by the mediated-agents on the plurality of auction, and/or reverse auction, web sites to facilitate an auction, or reverse-auction, effectively simultaneously on the plurality of web sites.

Other embodiments of the invention may be used to provide comparison-shopping functionality. Information relevant to a shopping transaction, such as credit card information, desired product identification, shipping address information and billing address information, can be stored within the user manager 360. Content can be collected by the mediated-agents from a plurality of product web sites and presented to the shopper. Additionally, information either stored in the user manager 360 or dynamically input by the user can be posted by the mediated-agents on a plurality of web sites to facilitate comparison-shopping. Thus, price comparisons can be effectively performed across a plurality of web sites effectively simultaneously in a manner transparent to the user.

Other embodiments of the invention can be used to efficiently gather information stored on a variety of data sources, including electronic files, web sites, data bases and legacy systems. The information collected by the mediated-agents is presented to the user in a unified format. The user may then initiate a variety of transaction requests on the presented information. The range of available actions that may be taken on the presented information include transaction requests that may be performed on any available data source, including data sources not used in collecting the information initially presented to the user. For example, if a search of a legacy system results in the name of a Latin expression, the user may then request the translation of the Latin expression and the mediated-agents will process the transaction request using one or more data translation data sources, e.g., one or more language translation service web sites.

VI. Addition Of A New Service

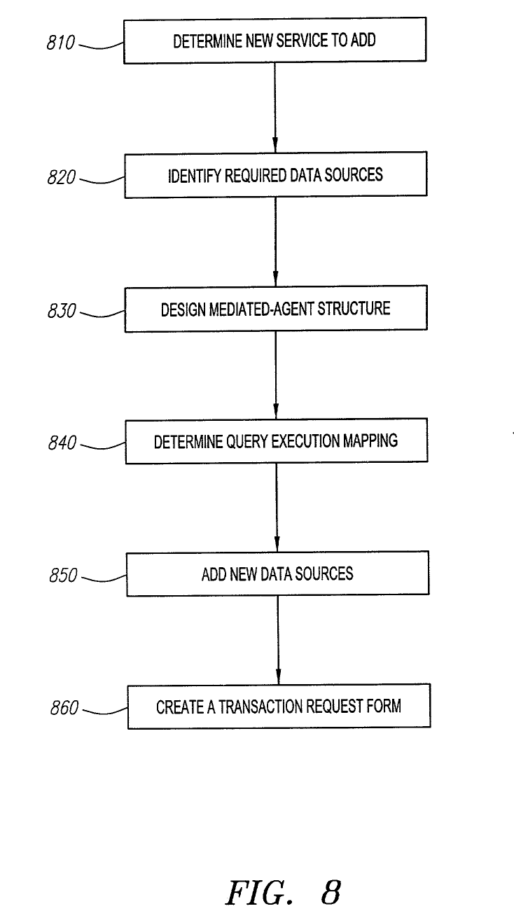

Having explained several examples of services provided by embodiments of the invention, the process of adding a new service to an integration engine 330 will now be discussed with reference to the flow chart of FIG. 8. Initially, the new service to included to augment the integration engine 330 is determined (810). The new service can expand or enhance the functionality of the integration engine 330 in any manner, such as, for example, enabling comparison-shopping, heterogeneous email checking, or any of the other invention embodiments previously discussed. Other services not described above, but within the scope of the teachings herein, can also be added to the integration engine 330. For ease of explanation, the process of adding a new service will be explained with reference to adding train reservation functionality to an existing integration engine 330.

After deciding (810) what new service is to be augmented to the integration engine 330, the data sources to support the new service are identified (820). In the example of adding train reservation functionality, data sources containing information corresponding to reserving tickets on trains, e.g., Amtrack's web site, are identified (820). The identified data sources include web sites for train lines that will be considered by the transaction processing system 300 when processing a train reservation transaction request, and can also include legacy systems, price lists, and other relevant databases.

In an embodiment, specific mediated-agents in the integration engine 330 are used to search for, and prioritize, data sources accessible by the transaction processing system 300 based on new service transaction request keywords. For example, the specific mediated-agents could search the data sources accessible by the transaction processing system 300 using the keyword “train,” or the keywords “train” and “reservation”.

In another embodiment, one or more existing mediated-agents that support current services in the transaction processing system 300 are used to search for, and prioritize, data sources for the new service using service-relevant keywords. In an embodiment, the one or more existing mediated-agents for searching for data sources to support a new service are mediated-agents that currently support a similar-type service, e.g., existing mediated-agents 335K-335R are used to search for the data sources to support the new train reservation transaction request service.

In an embodiment, all of the located data sources are then added to the transaction processing system 300. In another embodiment, a subset x of the located prioritized data sources are then added to the transaction processing system 300.

After determining the data sources (820) to be accessed to perform the new service, the structure of the mediated-agent tree branch for processing the new service is designed (830). As previously explained, the same service can be effectively implemented through a plurality of various mediated-agent 335 tree structures. In an embodiment, the structure for the mediated-agent tree branch supporting the new service is based, at least in part, on the current structure of the tree branches of mediated-agents 335 within the integration engine 330. The mediated-agent tree structure for supporting the new service is generated by adding additional functionality to the existing tree of mediated-agents in integration engine 330, by integrating new mediated-agents 335 into the current arrangement.

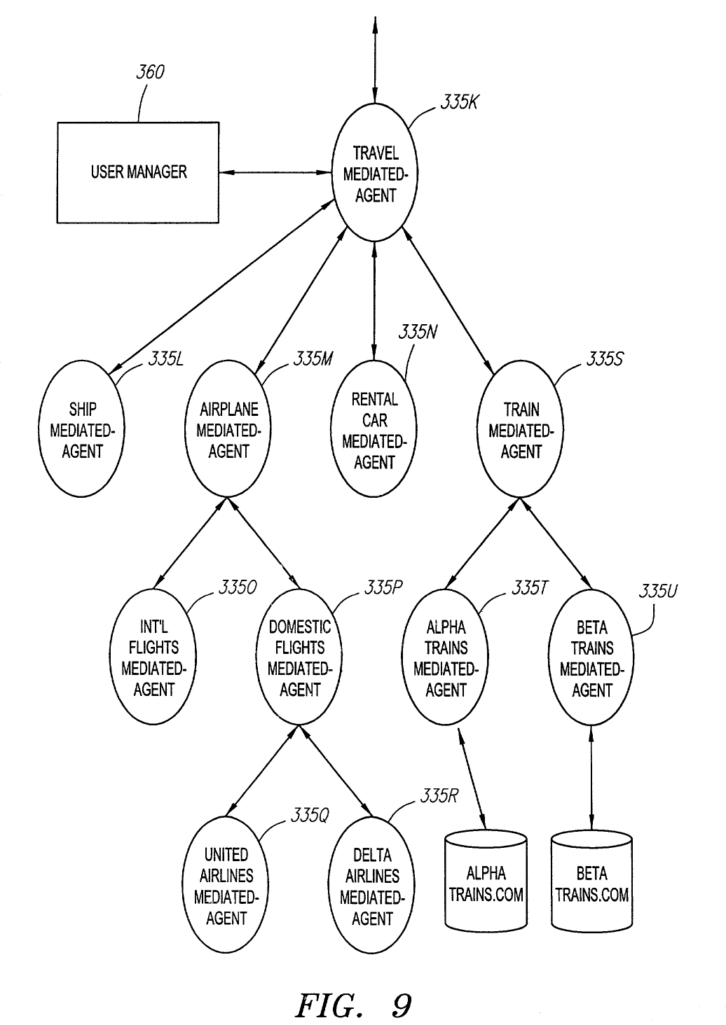

Newly integrated mediated-agents are assigned a set of one or more transaction request types they are responsible for servicing. For example, if a train reservation functionality is added to the mediated-agent structure illustrated in FIG. 7, and the new service accesses two train line web sites, Alpha Trains web site, and Beta Trains web site, the new mediated-agent structure could look as illustrated in FIG. 9.

After constructing the mediated-agent structure for the new service, the query execution mapping is determined (840) for the respective data sources for the new service. The parent nodes, e.g., travel mediated-agent 335K, and train mediated-agent 335S, are programmed to decompose various train reservation transaction requests into sub-queries. The leaf node mediated-agents for the new service, e.g., Alpha Trains mediated-agent 335T and Beta Trains mediated-agent 335U, are programmed to issue recognizable requests to the data sources, to extract information responsive to the train reservation transaction requests. The new leaf node mediated-agents are also programmed to be able to provide the necessary data, in the required format, to their data source. All child nodes, e.g., train mediated-agent 335S, Alpha Train mediated-agent 335T and Beta Train mediated-agent 335U, are programmed to initiate dialogs to obtain missing user-required information to finalize a transaction request.

After the mediated-agents are programmed, each new data source is added (850) to the integration engine 330. The process of adding (850) a new data source to the integration engine 330 is explained in further detail below.

In an embodiment, a user transaction request form is created (860), that is then displayed to the user when he or she wishes to format a new service, e.g., train reservation, transaction request, and/or, if user data required to complete the transaction request is missing.

VII. Addition Of A New Data Source

The process of adding a new data source to a transaction processing system 300 involves identifying the format that the new data source uses to store data. For example, to add a database, the database schema is determined. To add a web site, the structure of forms used on the web site, and the format in which data is displayed on the web site, is determined.

Next, a leaf node mediated-agent and, if necessary, a wrapper responsible for data interaction with the data source, are constructed. The leaf node mediated-agent is programmed with instructions to access and navigate to the new data source, as well as to interface with the data source's input interface. Where necessary, the mediated-agent will use the associated wrapper to assist with data communication with the data source, particularly with data extraction. The wrapper translates between the format for representing data used by the data source and the format for representing data used by the mediated-agent.

The newly constructed mediated-agent and wrapper are then programmed into the existing mediated-agent hierarchy in an appropriate position.

VIII. System Architecture Overview

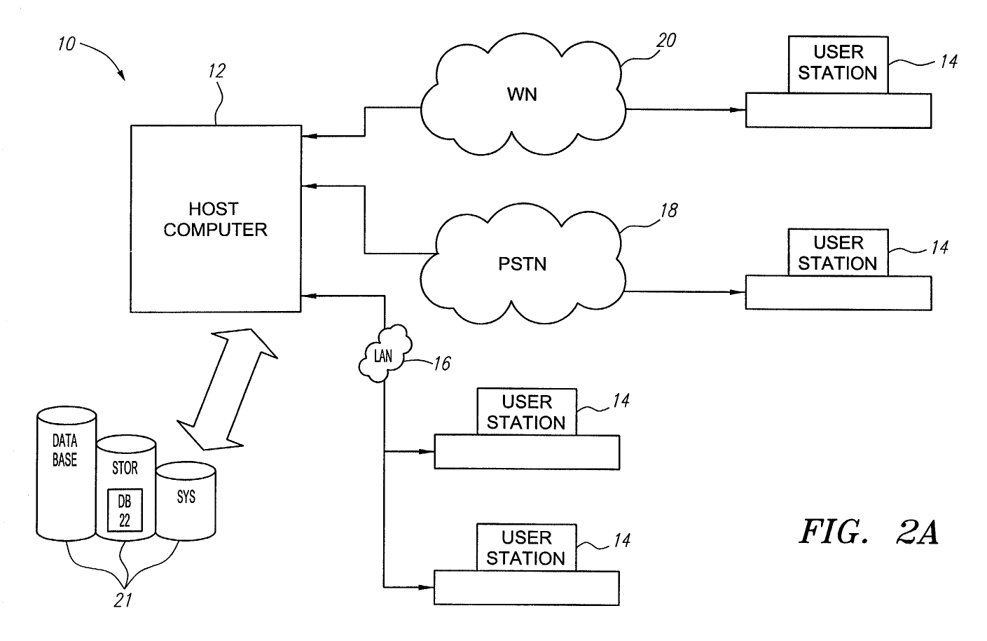

Referring to FIG. 2A, in an embodiment, a computer system 10 for supporting the integration engine 330 includes a host computer 12 connected, via a web server 320 (not shown in FIG. 2A), to a plurality of individual user stations 14. In an embodiment, the user stations 14 each comprise suitable data terminals, for example, but not limited to, personal computers, portable laptop computers, or personal data assistants (“PDAs”), which can access the internet. For purposes of illustration, some of the user stations 14 communicate with the host computer 12 via a local area network (“LAN”) 16. Other user stations 14 can remotely communicate with the host computer 12 via a public telephone switched network (“PSTN”) 18 and/or a wireless network 20.

In an embodiment, the host computer 12 operates in conjunction with a data storage system 21, wherein the data storage system 21 contains a database 22 that is readily accessible by the host computer 12. In an embodiment, the user profiles of the user manager 360 are stored in database 22.

In alternative embodiments, the database 22 may be resident on the host computer 12, stored, e.g., in the host computer's ROM, PROM, EPROM, or any other memory chip, and/or its hard disk. In yet alternative embodiments, the database 22 may be read by the host computer 12 from one or more floppy disks, flexible disks, magnetic tapes, any other magnetic medium, CDROMs, any other optical medium, punchcards, papertape, or any other physical medium with patterns of holes, or any other medium from which a computer can read.

In an alternative embodiment, the host computer 12 can access two or more databases 22, stored in a variety of mediums, as previously discussed.

Referring to FIG. 2B, in an embodiment, each user station 14 and the host computer 12, each referred to generally as a processing unit, embodies a general architecture 25. A processing unit includes a bus 26 or other communication mechanism for communicating instructions, messages and data, collectively, information, and one or more processors 27 coupled with the bus 26 for processing information. A processing unit also includes a main memory 28, such as a random access memory (RAM) or other dynamic storage device, coupled to the bus 26 for storing dynamic data and instructions to be executed by the processor(s) 27. The main memory 28 also may be used for storing temporary data, i.e., variables, or other intermediate information during execution of instructions by the processor(s) 27.

A processing unit may further include a read only memory (ROM) 29 or other static storage device coupled to the bus 26 for storing static data and instructions for the processor(s) 27. A storage device 30, such as a magnetic disk or optical disk, may also be provided and coupled to the bus 26 for storing data and instructions for the processor(s) 27.

A processing unit may be coupled via the bus 26 to a display device 32, such as, but not limited to, a cathode ray tube (CRT), for displaying information to a user or operator. An input device 34, including alphanumeric and other keys, is coupled to the bus 26 for communicating information and command selections to the processor(s) 27. Another type of user input device may include a cursor control 36, such as, but not limited to, a mouse, a trackball, a fingerpad, or cursor direction keys, for communicating direction information and command selections to the processor(s) 27 and for controlling cursor movement on the display 32.

According to one embodiment of the invention, the individual processing units perform specific operations by their respective processor(s) 27 executing one or more sequences of one or more instructions contained in the main memory 28. Such instructions may be read into the main memory 28 from another computer-usable medium, such as the ROM 29 or the storage device 30. Execution of the sequences of instructions contained in the main memory 28 causes the processor(s) 27 to perform the processes described herein. In alternative embodiments, hardwired circuitry may be used in place of or in combination with software instructions to implement the invention. Thus, embodiments of the invention are not limited to any specific combination of hardware circuitry and/or software.

The term “computer-usable medium,” as used herein, refers to any medium that provides information or is usable by the processor(s) 27. Such a medium may take many forms, including, but not limited to, non-volatile, volatile and transmission media. Non-volatile media, i.e., media that can retain information in the absence of power, includes the ROM 29. Volatile media, i.e., media that can not retain information in the absence of power, includes the main memory 28. Transmission media includes coaxial cables, copper wire and fiber optics, including the wires that comprise the bus 26. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

Common forms of computer-usable media include, for example: a floppy disk, flexible disk, hard disk, magnetic tape, any other magnetic medium, CD-ROM, any other optical medium, punchcards, papertape, any other physical medium with patterns of holes, RAM, ROM, PROM (i.e., programmable read only memory), EPROM (i.e., erasable programmable read only memory), including FLASH-EPROM, any other memory chip or cartridge, carrier waves, or any other medium from which a processor 27 can retrieve information.

Various forms of computer-usable media may be involved in providing one or more sequences of one or more instructions to the processor(s) 27 for execution. For example, the instructions may initially be provided on a magnetic disk of a remote computer (not shown). The remote computer may load the instructions into its dynamic memory and then transit them over a telephone line, using a modem. A modem local to the processing unit may receive the instructions on a telephone line and use an infrared transmitter to convert the instruction signals transmitted over the telephone line to corresponding infrared signals. An infrared detector (not shown) coupled to the bus 26 may receive the infrared signals and place the instructions therein on the bus 26. The bus 26 may carry the instructions to the main memory 28, from which the processor(s) 27 thereafter retrieves and executes the instructions. The instructions received by the main memory 28 may optionally be stored on the storage device 30, either before or after their execution by the processor(s) 27.

Each processing unit may also include a communication interface 40 coupled to the bus 26. The communication interface 40 provides two-way communication between the respective user stations 14 and the host computer 12, via the web server 320. The communication interface 40 of a respective processing unit transmits and receives electrical, electromagnetic or optical signals that include data streams representing various types of information, including instructions, messages and data.

A communication link 42 links a respective user station 14 and a host computer 12. The communication link 42 may be a LAN 16, in which case the communication interface 40 may be a LAN card. Alternatively, the communication link 42 may be a PSTN 18, in which case the communication interface 40 may be an integrated services digital network (ISDN) card or a modem. Also, as a further alternative, the communication link 42 may be a wireless network 20.

A processing unit may transmit and receive messages, data, and instructions, including program, i.e., application, code, through its respective communication link 42 and communication interface 40. Received program code may be executed by the respective processor(s) 27 as it is received, and/or stored in the storage device 30, or other associated nonvolatile media, for later execution. In this manner, a processing unit may receive messages, data and/or program code in the form of a carrier wave.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, and the invention can be performed using different or additional process actions, or a different combination or ordering of process actions. The specification and drawings are, accordingly, to be regarded in an illustrative rather than restrictive sense.

What is claimed is:

1. A method of performing a transaction on a network, comprising:
receiving a transaction request;
transmitting data for the transaction request to a first mediated-agent;
propagating data for the transaction request through a set of mediated-agents comprising the first mediated-agent and one or more leaf node mediated-agents;
executing a query at each of the one or more leaf node mediated-agents with a data source associated with the respective leaf node mediated-agent, wherein the query is related to the transaction request; and
transmitting information responsive to the transaction request.

2. The method of claim 1, wherein said step of executing a query at each of the one or more leaf node mediated-agents comprises extracting information from a particular data source using a wrapper.

3. The method of claim 1, further comprising the step of collecting response information corresponding to a result set for the transaction request.

4. The method of claim 3, further comprising the steps of:
collating the response information collected by the one or more leaf node mediated-agents; and presenting the transmitted information responsive to the transaction request to a user in a unified format.

5. The method of claim 4, wherein the response information is streamed to the user by an integration engine comprising the first mediated-agent and the one or more leaf node mediated-agents in real time.

6. The method of claim 1, wherein the first mediated-agent communicates with one or more child node mediated agents, and one of the child node mediated agents communicates with at least one of the one or more leaf node mediated-agents, the method further including the step of a first leaf node-mediated agent from the one or more leaf node mediated-agents using a dialog session to query a child node mediated-agent for information required by a data source to complete the execution of a query related to the transaction request.

7. The method of claim 6, further comprising the steps of:
transmitting a request for information from a first leaf node mediated-agent to a first child node mediated-agent;
the first child node mediated-agent determining that it does not have the information responsive to the request for information;
transmitting a request for information from the first child-node mediated agent to the first mediated-agent;
the first mediated-agent determining that it does not have the information responsive to the request for information;
transmitting a request for information from the first mediated-agent to a user manager;
retrieving information responsive to the request for information from the user manager;
transmitting the information responsive to the request for information from the user manager to the first mediated-agent;
transmitting the information responsive to the request for information from the first mediated-agent to the first child node mediated-agent; and
transmitting the information responsive to the request for information from the first child node mediated-agent to the first leaf-node mediated agent.

8. The method of claim 7, further comprising the step of using the information responsive to the request for information to complete a query with a data source.

9. The method of claim 1, further comprising the steps of:
transmitting a request for information to a user;
receiving information responsive to the request for information from the user; and
using the information responsive to the request for information to execute a query with a data source.

10. The method of claim 9, wherein said step of transmitting a request for information to a user is performed in real time.

11. A method for executing an operation on a network involving two or more data sources, comprising:
accepting a transaction request from a user;
parsing the transaction request into one or more queries;
transmitting one query to a first mediated-agent;
parsing the query received by the mediated-agent into two or more sub-queries;
transmitting each of the two or more sub-queries to a respective leaf node mediated-agent;
executing at each respective leaf node mediated-agent a request to a data source that is designed to extract information responsive to the sub-query from the data source;
receiving the information responsive to the sub-query from the data source at each respective leaf node mediated-agent;
transmitting the information responsive to the sub-query from each respective leaf node mediated-agent to the first mediated-agent;
transmitting all the information responsive to the sub-query received by the first mediated-agent to the user in a unified format.

12. The method of claim 11, wherein the step of executing a request to a data source at a respective leaf node mediated-agent comprises using a wrapper.

13. The method of claim 11, further comprising the steps of:
querying the user for information to be used for executing an operation on the network prior to the step of accepting a transaction request from a user; and
storing the information received from the user in response to the querying in a user profile stored in a user manager.

14. The method of claim 11, further comprising the steps of:
querying the user for information necessary for executing a request to a data source at a respective leaf node mediated-agent;
using the information supplied by the user in the request to the data source executed by the respective leaf node mediated-agent; and
storing the information supplied by the user in a user profile.

15. The method of claim 11, wherein each respective leaf node mediated-agent executes its request to a data source effectively simultaneously.

16. A system for executing a transaction request on a network, comprising:
one or more clients;
a web server;
a database of user profiles;
a plurality of data sources; and
a plurality of mediated-agents, wherein one or more of said plurality of mediated-agents each comprises the capability to extract data from one of said plurality of data sources and wherein said one or more of said plurality of mediated-agents each further comprises the capability to initiate a dialog to retrieve user information necessary to extract data from the respective one of said plurality of data sources.

17. The system of claim 16, further comprising one or more wrappers for use in extracting data from a respective data source.

18. The system of claim 17, wherein the capability to extract data from one of said plurality of data sources comprises issuing a request to one of said plurality of data sources that includes information required by the data source to service the request, and further includes using one of said one or more wrappers to format the request to the one of said plurality of data sources in the format expected by the data source.

19. The system of claim 16, wherein the plurality of mediated-agents are organized in tree structure, a subset of said plurality of mediated-agents are responsible for servicing a specific transaction request type, and the subset of said plurality of mediated-agents service the specific transaction request type by accessing one or more of said plurality of data sources in real time.

20. The system of claim 16, wherein a dialog to retrieve user information comprises a request for user information transmitted from a first mediated-agent to a second-mediated agent or to a user manager.
